(19) United States
(12) Patent Application Publication
(10) Pub. No.: US 2003/0182486 A1
(43) Pub. Date: Sep. 25, 2003

(54) Demand DMA

(76) Inventors: Calvin S. Taylor, Tigard, OR (US); Mark Peting, Tigard, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/734,535

(22) Filed: Dec. 11, 2000

(51) Int. Cl. G06F 13/00

(52) U.S. Cl. 710/305; 710/313; 710/110

(57) ABSTRACT

A system including a non-bus mastering target device that is equipped to request a bus master device to initiate a bus transaction, such as for example, a direct memory access by the target device. By providing the remote target device with the ability to request a bus master to initiate a transaction, overall system performance may be improved without requiring that the target device include unnecessary and expensive bus mastering logic.

### FIELD OF THE INVENTION

The invention relates generally to signal processing. More specifically, the invention relates to signal processing with respect to a bus architecture.

### BACKGROUND OF THE INVENTION

Direct memory access (DMA) is a capability provided by certain bus architectures that enables data transfers directly to and from system memory without first passing through a microprocessor. By eliminating the need for data to first pass through the processor, overall system performance may be accelerated. DMA is typically utilized in conjunction with mass-storage and data-acquisition devices where rapid data transfer between such devices and memory is preferred.

One example of a bus architecture that utilizes DMA transfers is a peripheral component interconnect (PCI) bus. A PCI bus architecture performs what is known as “first party” DMA where the device or peripheral doing the transfer actually takes control of the bus to perform the transfer. In PCI parlance, devices that can take control of a bus are referred to as bus masters and devices that are the subject of the transfer are referred to as slaves or “targets.” With the assistance of arbitration circuitry, PCI bus architecture supports multiple bus masters on the same bus as well as the bus mastering of multiple remote devices such that no device on the bus locks out any other device. Once a bus master has arbitrated for and won access to the bus it is referred to as an “initiator” of a transaction.

FIG. 1 is a block diagram illustrating a prior art system including conventional bus master and remote (target) devices. Referring to FIG. 1, system 100 includes processor 14, memory 16, host bridge 12, arbiter 1, bus masters 7 and 9, and remote devices 3 and 5.

Processor 14 represents a general purpose microprocessor to process instructions and data within system 100. Memory 16 represents random access memory (RAM) to store instructions and data to be processed by processor 14. Processor 14 and memory 16 are coupled to host bridge 12 by way of processor bus 13 and memory bus 15 respectively.

Host bridge 12 represents a device to bridge signals between two independently operable buses. In system 100, host bridge 12 couples processor bus 13 and memory bus 15 to PCI bus 6. PCI bus 6 includes data bus 4, upon which address information and data are communicated, and control bus 2, upon which PCI control signals are communicated. Host bridge 12 includes arbiter 11 which represents circuitry to arbitrate between devices on PCI bus 6 such that no one bus master is locked out of obtaining access to the bus by any other bus master.

Bus masters 7 and 9, and remote devices 3 and 5 are each coupled to both data bus 4 and control bus 2. Bus masters 7 and 9 represent devices equipped to take control of data bus 4 and control bus 2, whereas remote devices 3 and 5 function solely as target devices, e.g., PCI target devices, and do not have bus mastering capabilities. Often, devices on a PCI bus are equipped to function as both a bus master device and a target device depending upon the design of the device. For example, assume a first PCI device designated as a bus master (e.g. a hard drive) initiates a first transaction with a second PCI device designated as a target (e.g. a MODEM). If configured to do so, the second PCI device (e.g. MODEM) that was designated as a target in the first transaction could, in a later transaction, initiate a transaction designating the first PCI device (e.g. hard drive) as a target.

In conventional bus architectures that provide master-slave functionality, such as PCI bus 6, transactions may only be initiated by bus master devices (e.g. bus masters 7 and 9). Devices that do not provide bus mastering capability must be polled or queried periodically by the appropriate bus master rather than transferring data in response to a triggering event in the slave device. This leads to latency increases and throughput decreases. With regard to latency increases, since a slave device cannot communicate that it is ready to transmit or receive data to the device initiating the transfer, it must wait until it is polled. During this time, the data sits, unmoving, ready to transfer. In regard to throughput degradation, it is possible to minimize this by allowing other devices to use the bus. However, the requirement that the bus be polled periodically, regardless of whether there is data to be sent means that some of the bus bandwidth is used up by the activity that does not directly transfer data.

One solution to this throughput problem is to equip the remote device with sufficient circuitry such that the remote device may itself function as a bus master and thus control access to the bus. By controlling the bus, the remote device can temporarily lock-out other devices from utilizing the bus based upon a predetermined arbitration scheme. Unfortunately, however, the circuitry required to implement bus master functionality within a remote device is not always desirable. If the remote device is representative of a class of thin clients or inexpensive appliances having minimum circuitry and limited functionality, the addition of such bus master circuitry and/or large number of additional connector pins may very well defeat the purpose and benefits of such a simple device.

### SUMMARY OF THE INVENTION

[TO BE COMPLETED]

### BRIEF DESCRIPTION OF THE DRAWINGS

The invention is illustrated by way of example, and not by way of limitation in the figures of the accompanying drawings in which like reference numerals refer to similar elements.

FIG. 1 is a block diagram illustrating a system including conventional bus master and remote target devices based upon the prior art.

FIG. 2 is a block diagram illustrating request circuitry according to one embodiment of the invention.

FIG. 3 is a block diagram illustrating request circuitry according o one embodiment of the invention.

FIG. 4 is a block diagram illustrating further detail of two remote devices according to one embodiment of the invention.

FIG. 5 is a timing diagram illustrating bus signaling for a write transaction according to one embodiment of the invention.

### DETAILED DESCRIPTION

The system described herein includes a non-bus mastering target device equipped to request a bus master device to initiate a bus cycle and ultimately a bus transaction, such as a DMA transaction, or a data transfer from a data source to a non-bus mastering target device via a bus master device. By providing the remote target device with the ability to request that a bus master initiate a transaction, overall system performance may be improved without requiring the target device to include unnecessary and expensive bus mastering logic.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

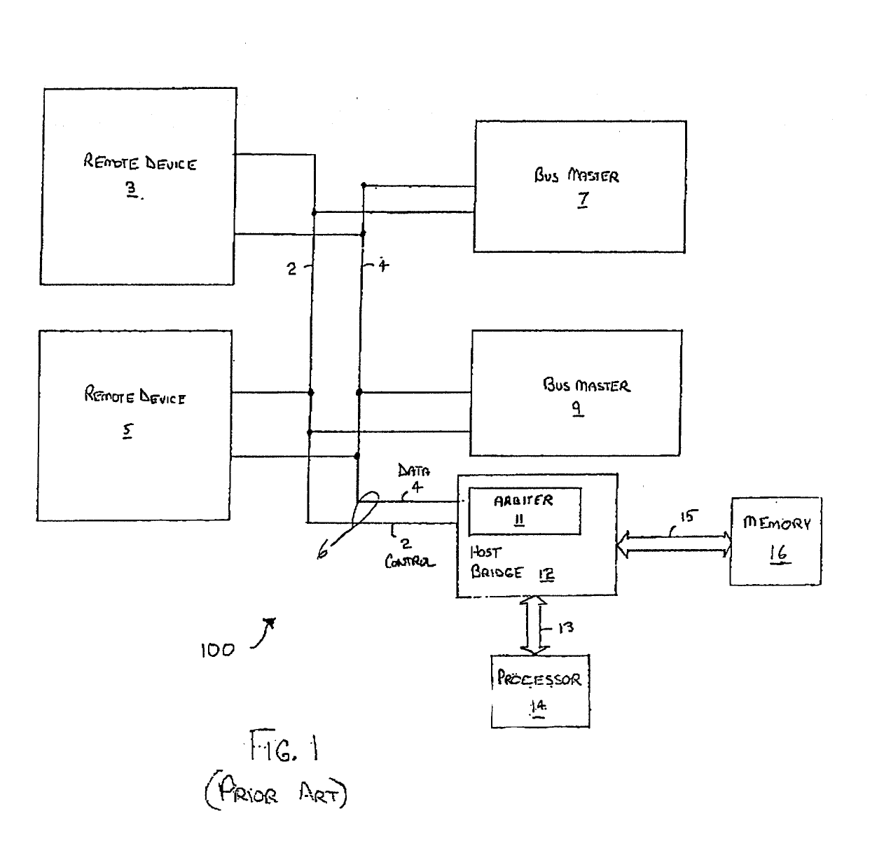

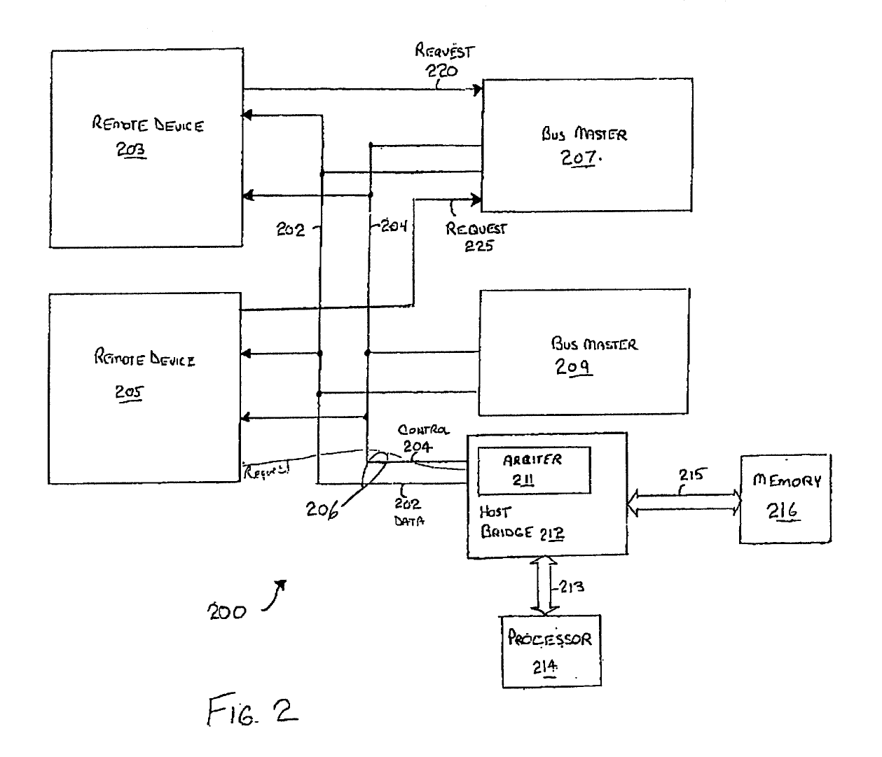

FIG. 2 is a block diagram illustrating a system including bus master and remote target devices along with request circuitry according to one embodiment of the invention. FIG. 2 illustrates system 200 configured in a manner similar to that of system 100 of FIG. 1. System 200 includes processor 214, memory 216, host bridge 212, arbiter 211, bus masters 207 and 209, and remote devices 203 and 205. Processor 214 represents one or more devices known in the art to process data, and is coupled to host bridge 212 via processor bus 213. Memory 216 is coupled to host bridge 212 via memory bus 215 and represents anyone of a variety of RAM devices known in the art to store data for processing, such as for example, DRAM, SRAM, RDRAM, etc. Host bridge 212 serves as an interface between local bus 206, processor bus 213, and memory bus 215. In one embodiment, host bridge 212 includes a memory controller (not pictured) that services memory access requests initiated by processor 214 or local bus 206. In one embodiment, host 212 is equipped to function as a bus master device initiating transactions on local bus 206.

Local bus 206 represents a data communication bus that couples bus master 207, bus master 209, remote device 203, and remote device 205 together with host bridge 212. Local bus 206 includes data bus 202 and control bus 204, which respectively provide data and control signaling across local bus 206. In one embodiment, data bus 202 is coupled to each of bus masters 207 and 209 at a data bus interface. Similarly, in one embodiment, control bus 204 is coupled to each of bus masters 207 and 209 at a control bus interface. In one embodiment, local bus 206 is a PCI bus. In other embodiments, local bus 206 may be configured to operate in accordance with other bus architectures known in the art. In order to not obscure the invention, however, the functionality of local bus 206 will be described only with respect to a PCI-compliant bus. It is appreciated that in another embodiment, arbiter 211 may be separate from host bridge 212 and coupled directly to local bus 206.

In addition to data bus 202 and control bus 204, system 200 includes request line 220 coupled to bus master 207 and remote device 203, and request line 225 coupled to remote device 205 and bus master 207. In one embodiment, request lines 220 and 225 each represent a single signal trace, whereas in another embodiment request lines 220 and 225 each may represent multiple signal traces. In other embodiments, request lines 220 and 225 may each be implemented in a transmitter/receiver arrangement where signal transmission takes place from one device to another through free space (i.e. atmospherically) rather than through a physical connection. It should be noted, however, that such non-physical connections may require additional circuitry over that required by a single physical signal trace. Through request lines 220 and 225, remote devices 203 and 205 respectively, can request that bus master 207, for example, initiate a bus cycle.

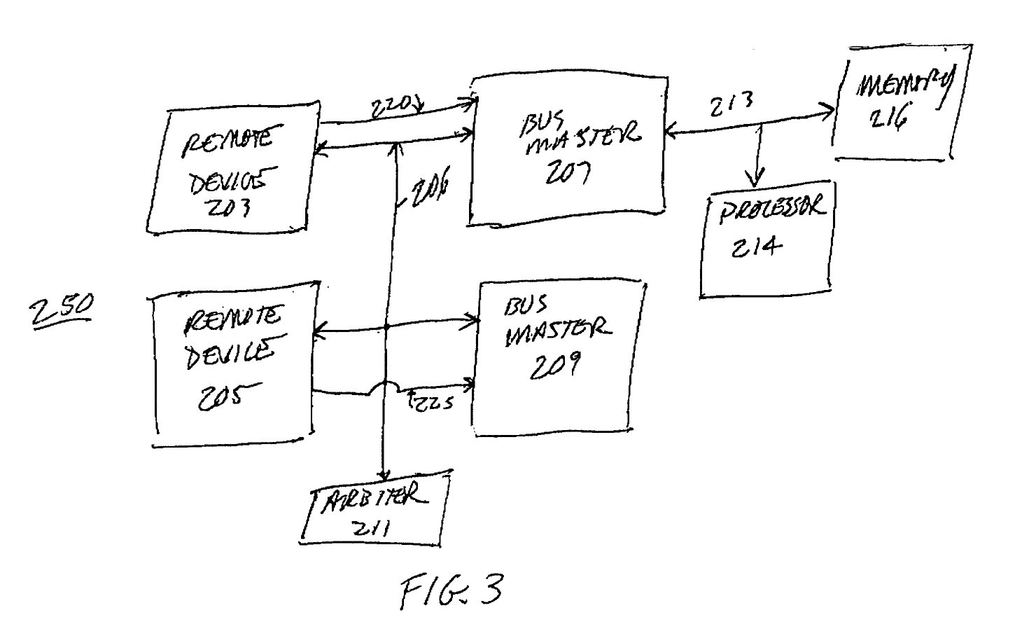

FIG. 3 is a block diagram illustrating a system 250 as may be embodied by the present invention, including bus master and remote target devices along with request circuitry according to one embodiment of the invention. System 250 includes processor 214, memory 216, arbiter 211, bus masters 207 and 209, and remote devices 203 and 205. Processor 214 represents one or more devices known in the art to process data, and is coupled to bus master 207 via system bus 213. Memory 216 is coupled to bus master 207 via system bus 213 and represents anyone of a variety of RAM devices known in the art to store data for processing, such as those previously mentioned. Bus master 207 serves as a bridge interface between local bus 206 and system bus 213. In one embodiment, bus master 207 services memory access requests initiated by processor 214 or local bus 206. Unlike the embodiment illustrated in FIG. 2, Arbiter 211 is coupled directly to local bus 206 in the embodiment illustrated in FIG. 3. Other than as noted in this paragraph, the embodiment illustrated in FIG. 3 is similar in architecture and operation as the embodiment described above with respect to FIG. 2.

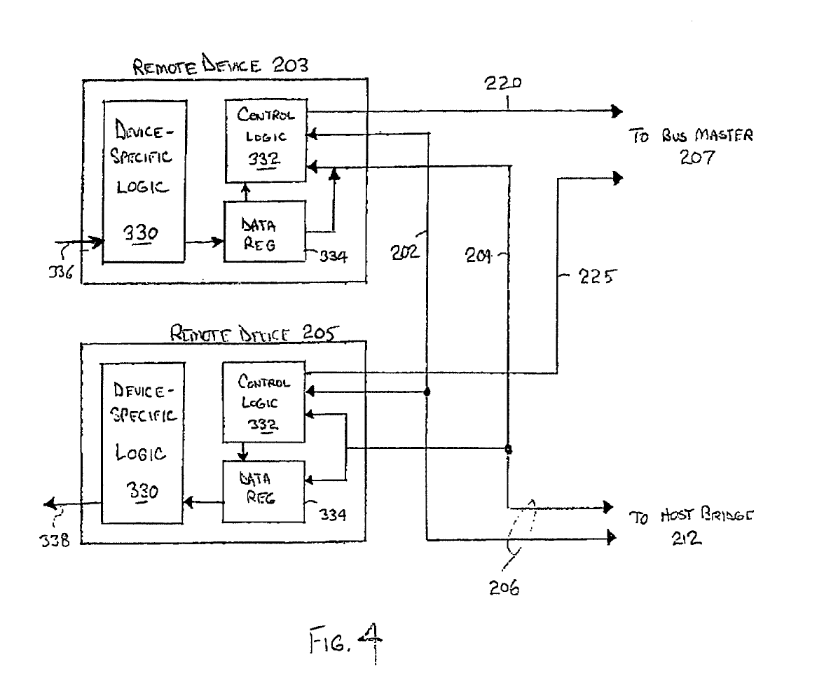

FIG. 4 is a block diagram illustrating further detail of two remote devices according to one embodiment of the invention. Remote device 203 and remote device 205 each include device-specific logic 330, control logic 332, and data registers 334. Device-specific logic 330 represents logic specific to the functionality of the device within which the logic is located. Device-specific logic 330 may vary from one remote device to another and should not be viewed as limiting the invention disclosed herein. For example, if a remote device represents a scanner interface, device-specific logic 330 may include an optical character recognition engine to recognize scanned data. If, however, a remote device represents a MODEM for example, device-specific logic 330 may include a universal asynchronous receiver-transmitter (UART) and not an optical character recognition engine.

In addition to device-specific logic 330, remote devices 203 and 205 further include data registers 334. Data registers 334 represent one or more data buffers to temporarily store data and control information in the remote devices. Remote device 203 includes input signal line 336, whereas remote device 205 includes output signal line 338. In one embodiment, remote device 203 receives data through signal line 336 and temporarily stores the data within data registers 334. According to conventional implementations, the data is stored in the internal data buffers of the remote device until a bus master could initiate a bus cycle to transfer the data out of the remote device. Additionally, remote device 205 transmits data stored in data registers 334 through signal line 338. According to one implementation, data would be stored in the internal data buffers of remote device 205 until a bus master could initiate a bus cycle to transfer the data out of the remote device on signal line 338. When the data buffers of either remote device can accept data, the bus master initiates a bus cycle to transfer data to the remote device.

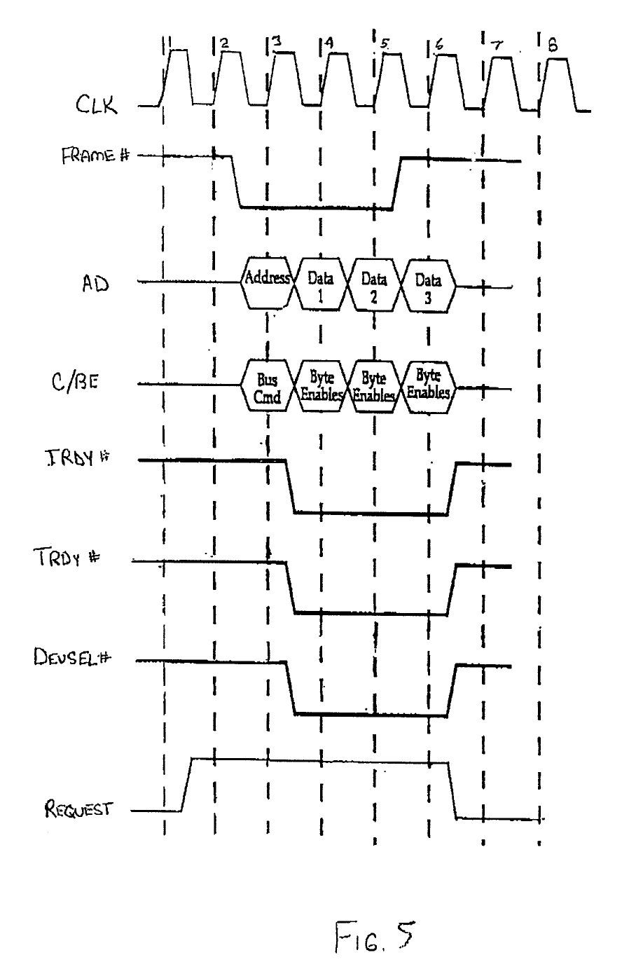

According to one embodiment of the invention, remote devices 203 and 205 are provided with simple logic to timely request that a bus master initiate a bus cycle when the remote device's data buffers have data to transfer from their buffers. In remote device 203, for example, control logic 332 is equipped to detect when data register 334 approaches or achieves a certain data storage threshold, and in response, assert request line 220 to request bus master 207 to initiate a bus cycle. Once bus master 207 detects request line 220 asserted, it initiates a bus cycle (as shown in FIG. 5). If the bus cycle includes a memory write transaction, data may be transferred from remote device 203 to any number of devices such as bus master 207 or host bridge 212 prior to being written to memory. For example, if the data is temporarily stored in bus master 207 or host bridge 212 prior to being written to memory, the system can make more efficient use of the system buses (e.g. memory and processor buses) by not wasting precious cycle time on piecemeal data transfers from the remote device to memory. By buffering the data at the bus master or host bridge, for example, rather than the remote device, the system is able to accumulate a quantum of data and then efficiently burst the data onto the bus to memory while avoiding data overflows in the remote device. Furthermore, by limiting the amount of data that a remote device is required to store, the size and/or number of data buffers located within the remote device may be decreased.

It should be noted that although remote device 203 is shown as a data collection (i.e. source) device and remote device 205 is shown as a data output (i.e. sink) device, each remote device may nonetheless function as a source and/or sink of data without departing from the spirit and scope of the invention.

The operation of remote devices thus far suggests a push model, that is, the remote devices request transfer of data when the remote devices have data to send. It is appreciated that the remote devices may operate in a pull model as well, wherein the remote devices request transfer of data to the buffers o the remote devices when the devices are ready to receive data. According to one embodiment of the invention, remote devices 203 and 205 could utilize the same simple logic to timely request that a bus master initiate a bus cycle when the remote device's data buffers are ready to receive data.

Control logic 332 represents logic known in the art to latch information off of, as well as place information onto data and control buses 202 and 204. In one embodiment, control logic 332 includes an additional gate to control activation of request lines 220 and 225. In one embodiment, each request line is coupled to a remote device and a bus master device. In one embodiment, a bus master is equipped to receive multiple request lines, each of which terminates at a different remote device. In such a case where multiple request lines terminate at a single bus master, the bus master may utilize poling logic to detect which of the multiple request lines are asserted at any given time. If the bus master determines that multiple request lines are asserted, the bus master may utilize a fairness routine to determine which remote device's request should be honored first. In one embodiment, the bus master includes decode logic to determine a bus address for the remote device associated with the request selected by the bus master.

Once the bus master determines the remote device bus address, the bus master places the address on the bus (e.g. local bus 206) to be latched by all remote devices coupled to the bus.

FIG. 5 is a timing diagram illustrating bus signaling for a write transaction according to one embodiment of the invention. The horizontal axis of the timing diagram is divided into eight equal clock (CLK) cycles. The vertical axis of the timing diagram is divided into seven representative PCI bus signals including FRAME#, AD, C/BE#, IRDY#, TRDY#, DEVSEL#, and REQUEST, where the “#” symbol indicates that the signals are asserted active low. It will be appreciated that with minor modifications, the signals could likewise be asserted active high.

FRAME# represents a cycle frame signal that is driven by the initiator and indicates the start and duration of a transaction on the PCI bus. In order to determine that bus ownership has been acquired, the bus master samples FRAME# and IRDY# (described below) both deasserted on the same clock signal.

AD represents a data bus upon which address and data information is passed, and C/BE represents a Command/Byte enable bus (i.e. control bus) upon which transaction and control commands are passed.

IRDY# represents an initiator ready signal that is driven by the current bus master. During a write transaction, IRDY# asserted indicates that the initiator is driving valid data (AD) onto the data bus, whereas during a read transaction, IRDY# asserted indicates that the initiator is ready to receive data from the currently-addressed target.

TRDY# represents a target ready signal that is driven by the currently-addressed target. TRDY# is asserted when the target is ready to complete the current data transfer. A data transfer is completed when the target asserts TRDY# and the initiator asserts IRDY# on the same clock signal.

DEVSEL# represents a device select signal that is asserted by the remote device when, after latching and decoding an address on the data bus, the remote device determines that it is the designated target. If a master initiates a transfer and does not detect a DEVSEL# asserted by any remote device within a specified number of clock cycles, it assumed the device(s) cannot respond or that the address is not valid.

REQUEST# represents a signal asserted by the remote device to request that the bus master initiate a bus cycle. In one embodiment, REQUEST# is communicated to the bus master via request lines 220 and/or 225 in FIGS. 2-3.

According to one embodiment of the invention, when a remote device is ready for a bus master to initiate a bus cycle, the remote device asserts a REQUEST signal. In one embodiment, the remote device asserts the REQUEST signal for a variable length of time depending upon the status of the remote device. For example, the remote device may keep REQUEST asserted for as long as the data buffers within the remote device remain above a certain percentage full. Once the bus master detects REQUEST asserted, the bus master arbitrates control of the bus with other bus masters that may be present. Assuming the bus master detects REQUEST asserted and is granted control of the bus, the bus master (now initiator) performs three substantially simultaneous tasks. The initiator (a) drives the start address onto the address bus, (b) drives the transaction type (i.e. memory write) onto the C/BE bus, and (c) asserts FRAME# (CLK2) to indicate the beginning of a transaction. Once the initiator asserts FRAME#, it asserts IRDY# indicating that the initiator is driving valid data onto the bus, or that the initiator is ready to accept data from the currently-addressed target (i.e. a read transaction).

Each PCI target latches each address present on the bus and decodes the latched addresses to determine if it is being addressed. When a PCI target determines that it is the target being addressed, it claims the transaction by asserting DEVSEL# (CLK3). In addition to DEVSEL#, the target also asserts TRDY# (CLK3) indicating its willingness to accept the first data item. It should be noted that in a read transaction, wait states or “turn-around cycles” may be inserted between IRDY# asserted and TRDY# asserted due to bus ownership concerns. IRDY#, TRDY#, and DEVSEL# remain asserted until the initiator deasserts FRAME# indicating that it is ready to complete the final data phase (CLK5). Once the target is ready to complete the final data phase, it deasserts TRDY#, DEVSEL#, and REQUEST (CLK6). Additionally, the initiator deasserts IRDY# (CLK6) returning the bus to an idle state. Thus, a request DMA architecture has been disclosed.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A system comprising:
a bus master device;
a remote device;
a data bus coupled to the remote device and the bus master device; and
a request line coupled to the remote device and the bus master device that when asserted by the remote device, causes the bus master device to initiate a data transfer over the data bus.

2. The system of claim 1, wherein the request line comprises a single signal trace.

3. The system of claim 1, wherein the data is transferred from the remote device to the bus master device.

4. The system of claim 1, wherein the data is transferred from the bus master device to the remote device.

5. The system of claim 1, wherein the data bus comprises a PCI data bus.

6. The system of claim 5, wherein the data transfer comprises a DMA data transfer.

7. The system of claim 1, further comprising a control bus coupled to the remote device and the bus master device to transmit control signals between the remote device and the bus master device.

8. The system of claim 1, further comprising:
a second remote device; and
a second request line coupled to the second remote device and the bus master device that when asserted by the second remote device, causes the bus master device to initiate a data transfer over the data bus.

9. A target device comprising:
a bus interface to couple the target device to a data bus;
a request interface to couple the target device to a bus master; and
control logic to generate a request signal to be transmitted to the bus master via the request interface such that the bus master initiates a bus cycle in response to the request signal.

10. The target device of claim 9, wherein the bus comprises a PCI bus.

11. The target device of claim 9, wherein the bus cycle effects a data transfer from the target device over the data bus.

12. The target device of claim 9, wherein the bus cycle effects a data transfer from the target device to a master device over the data bus.

13. The target device of claim 9, wherein the bus cycle effects a data transfer to the target device.

14. The target device of claim 9, wherein the bus cycle effects a data transfer from a master device to the target device over the data bus.

15. The target device of claim 9, wherein the bus cycle effects data transfer from the, target device to a host memory device over the data bus.

16. The target device of claim 9, wherein the request interfaces comprises a signal line.

17. A PCI bus master comprising:
a control bus interface;
a data bus interface; and
a request interface to receive a request signal from a remote device coupled to the PCI bus master that when received, causes the PCI bus master to initiate a bus cycle.

18. The PCI bus master of claim 17, wherein the bus cycle effects a data transfer from the remote device to the PCI bus master.

19. The PCT bus master of claim 17, wherein the bus cycle effects a data transfer from the PCI bus master to a remote device.

20. The PCI bus master of claim 17, wherein the bus cycle effects a data transfer from the remote device.

21. The PCI bus master of claim 17, wherein the bus cycle effects a data transfer from the remote device to host memory via the PCI bus master.

22. The PCI bus master of claim 17, wherein the bus cycle effects a data transfer from host memory to the remote device via the PCI bus master.

23. The PCI bus master of claim 17, wherein the request interface is equipped to receive a plurality of request signals from a corresponding plurality of remote devices.

24. The PCI bus master of claim 17, wherein the request signal is received through a single signal trace coupled to the PCI bus master.
